(19) United States
(12) Patent Application Publication
(10) Pub. No.: US 2026/0004691 A1
(43) Pub. Date: Jan. 1, 2026

(54) DEMURA GAIN GENERATION USING CONTROL LOOPS

(71) Applicant: Microsoft Technology Licensing, LLC, Redmond, WA (US)

(72) Inventors: Ruipeng SUN, Pleasanton, CA (US); Chuan PU, Foster City, CA (US); Wenjun LIAO, Sunnyvale, CA (US)

(73) Assignee: Microsoft Technology Licensing, LLC, Redmond, WA (US)

(21) Appl. No.: 18/757,294

(22) Filed: Jun. 27, 2024

(51) Int. Cl. G09G 3/20; G06T 7/00

(52) U.S. Cl. CPC G09G 3/20; G06T 7/0002; G06T 2207/10016; G06T 2207/30168; G09G 2320/0233; G09G 2320/043; G09G 2320/0693

(57) ABSTRACT

Implementations of demura gain generation using control loops are provided. One aspect includes a method for performing demura gain generation, the method comprising: initializing a demura look-up table with initial values; receiving pixel information for a plurality of pixels from a display panel; and, for each of the plurality of pixels, calculating an error based on the pixel information of the pixel and a corresponding target value; applying a control loop to the error to generate a control loop output; and updating the demura look-up table for the pixel based on the control loop output.

### BACKGROUND

Demura refers to processes and techniques for the correction of mura effects, which are a category of display defects generally characterized by a “clouding” appearance that manifests when the outputs of individual pixels of the display deviate from their intended values (e.g., brightness, chromaticity, etc.). These effects can be caused by, for example, imperfect illumination of an electronic display resulting from the fundamental design and manufacturing of such displays and are largely unavoidable. Other factors, such as aging and usage of the display, can also contribute to the mura effects.

One class of demura techniques includes utilizing demura look-up table (LUT) gain generation to provide parameters that can be used to improve the visual quality and consistency of flat panel displays, which can be important for various applications including large-scale and tiled applications. Demura LUT gain generation refers to processes of creating a LUT of parameters that compensate for the brightness variations of a given display panel. The process generally involves measuring the characteristics of a panel, calculating the optimal gain values for each pixel of the panel, and storing them in a memory device for use by the panel. The LUT can then be used to adjust the input signals to achieve a uniform, or more uniform, output.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Implementations of demura gain generation using control loops are provided. One aspect includes a method for performing demura gain generation, the method comprising: initializing a demura look-up table with initial values; receiving pixel information for a plurality of pixels from a display panel; and, for each of the plurality of pixels, calculating an error based on the pixel information of the pixel and a corresponding target value; applying a control loop to the error to generate a control loop output; and updating the demura look-up table for the pixel based on the control loop output.

### BRIEF DESCRIPTION OF THE DRAWINGS

FIG. 1 shows a block diagram of an example computing system for performing demura look-up table gain generation using control loops.

FIG. 2 shows a block diagram of an example algorithm for performing demura look-up table gain generation using control loops, which can be implemented using the example system of FIG. 1.

FIG. 3 shows a block diagram illustrating g an example proportional-integral-derivative control loop, which can be implemented in the example algorithm of FIG. 2.

FIG. 4 shows a flow diagram of an example method for performing demura look-up table gain generation using control loops, which can be implemented using the example system of FIG. 1.

FIG. 5 shows a schematic view of an example computing system, which can be implemented as the computing system of FIG. 1.

### DETAILED DESCRIPTION

Flat-panel displays (e.g., liquid-crystal display (LCD), light-emitting diode (LED), organic LED (OLED), quantum dot LED (QLED), micro-LED (μLED), etc.) are widely used in various applications, including but not limited to smartphones, tablets, laptops, television (TV) devices, monitors, and augmented reality/virtual reality (AR/VR) displays. However, these displays often suffer from manufacturing defects and/or aging effects that cause brightness and/or chromaticity non-uniformity across pixels. For example, in many emissive displays, each pixel is controlled independently to emit light using electrical signals. Even with the same electrical signal input controlling a set of pixels, inconsistent luminance and chromaticity can occur from pixel to pixel. These variances can result in artifacts that manifest as visual defects (e.g, mura effects), affecting the quality and performance of the display and degrading the image quality and intended user experience. Furthermore, these artifacts can cause eye fatigue, headache, nausea, and/or motion sickness, especially in AR/VR applications.

One class of techniques for correcting mura and/or other non-uniformity issues (e.g., clouding, banding, burn-in, etc.) includes demura LUT gain generation. A demura LUT can be implemented as a data structure that stores correction values for each pixel of a display. The correction values can be calculated based on the measured luminance and/or chromaticity of the pixels, which may vary due to manufacturing variations, aging effects, and/or environmental factors. Demura processes are generally implemented as in-line correction processes (e.g., during manufacturing and during usage) that adjust the color and/or brightness of each pixel to compensate for display artifacts and to improve the display quality. Current methods for generating a demura LUT generally include capturing image of a video once for a given display, calculating the gain LUT, and then reusing the calculated gain LUT for subsequent frames. Such methods have low computational cost and memory usage but present many challenges. For example, a one-time demura LUT gain generation methodology assumes that the scene illumination, camera settings, and other environmental factors are constant throughout the video. In reality, the frames vary from one another (even when controlled using the same signal input) due to various environmental factors that can be difficult to control during the recording of the video. For example, camera exposure, white balance, changes in ambient lighting, etc. can all affect the luminance, accuracy, and/or quality of the final image output by the display, causing noticeable inconsistencies across the video recording. As such, using one frame of the video as a baseline for every other frame can lead to a demura LUT that poorly reflects the characteristics of the display, leading to poor non-uniformity corrections.

In view of the observations above, techniques for demura LUT gain generation using control loops are provided. Processes for demura LUT gain generation using control loops can be implemented in various ways. In some implementations, the process includes an iterative method using at least one control loop that updates the demura LUT based on feedback from multiple image captures. Different types of control loops can be implemented. In some implementations, the process utilizes a proportional-integral-derivative (PID) controller. A PID controller implements a PID control loop that provides a feedback mechanism to adjust the output of a system based on the difference between the desired and actual values of a variable. Demura LUT gain generation using a control loop can iteratively compare a current frame with the previous frame, allowing for the detection of changes in environmental factors such as scene illumination, camera settings, etc. When changes are detected, the demura LUT can be adjusted accordingly and applied to the following frame. Such techniques provide several technical advantages. For example, such techniques provide for maintaining consistent and accurate illumination information throughout a video recording of a display while still reducing computational cost and memory usage compared to traditionally methods of generating a demura LUT for each frame.

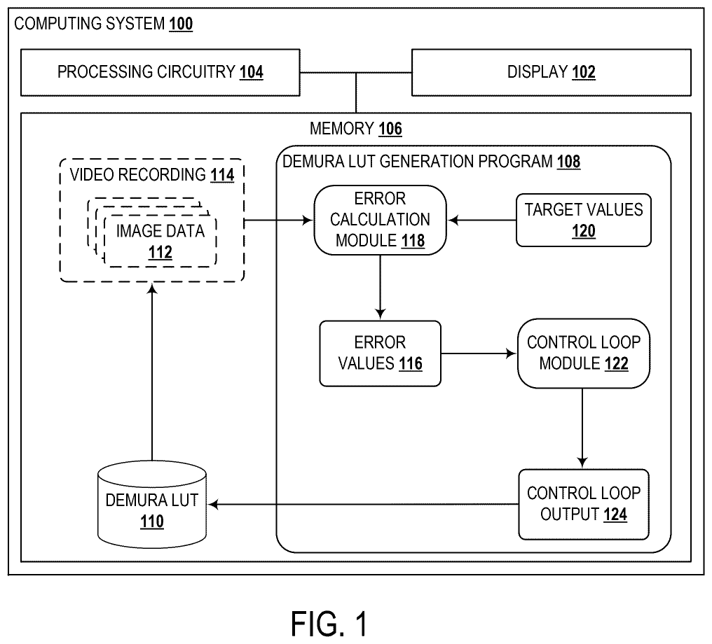

Turning now to the figures, demura LUT gain generation techniques using control loops are described in further detail. FIG. 1 shows a block diagram of an example computing system 100 for performing demura look-up table gain generation using control loops. The example computing system 100 can be implemented with various types of computing devices, including mobile devices, smart phones, personal computers, laptops, computing servers, remote servers, cloud-computing devices, head-mounted displays, etc. The example computing system 100 includes a display device 102 for which the demura look-up table gain generation process is performed. Various types of display devices can be implemented. Examples of displays include LCD, LED, OLED, QLED, and μLED. In some implementations, the example computing system 100 includes a computing device in remote communication (e.g., cloud computing system) with the display device 102. For example, information from the display device 102 can be recorded and sent to the remote device for processing and computations. The example computing system 100 can include various other components. For example, the system 100 can include a camera system for capturing the output of the display 102.

The example computing system 100 further includes processing circuitry 104 and memory 106 storing instructions that, during execution, causes the processing circuitry 104 to perform the various processes described herein. In the depicted example, the memory 106 stores a demura LUT generation program 108 that includes various modules for generating/updating a demura LUT 110 using one or more control loops in an iterative manner. The process can be performed at various stages of the display's lifetime. In some implementations, the demura LUT 110 is generated as part of quality assurance for the manufacturing process of the display 102. In some implementations, the demura LUT is generated during/over the course of normal usage of the display. For example, the demura LUT 110 can be updated or replaced periodically (e.g., weekly, monthly, upon every startup of the display, etc.) as mura effects can manifest from normal usage of the display 102 over time. In some implementations, the demura LUT 110 is generated or updated during a time when environmental factors are more known. For example, calibration of the display 102 can provide different results in different lighting (e.g., calibrating the display 102 in the morning can yield different results than when calibrating in the afternoon). As such, the example computing system 100 can be configured to perform the demura LUT generation process when ambient lighting is stable (e.g., indoor lighting).

The demura LUT generation process starts with first providing a demura LUT 110. The initial demura LUT can be provided in various ways. In some implementations, the initial demura LUT utilized in the demura LUT generation process is a LUT previously generated by another LUT generation process. In other implementations, the initial demura LUT is provided by generating a new LUT initialized with predetermined values (e.g., zeroes, ones, average correction values, etc.). For example, a LUT containing gain values can be initialized with ones. In another example, a LUT containing absolute correction values can be initialized with zeroes.

The process for updating the demura LUT 110 includes receiving image data 112 corresponding to an output image of the display 102 configured for the performance of the demura LUT generation process. The image data 112 can be of any image format and can be provided from various sources. In some implementations, the image data 112 includes an image frame retrieved from a video recording 114 of the display device 102. In such cases, further processing can be performed on subsequent image frames of the video recording 114. Various methods can be utilized to obtain the image data 112. For example, a camera or colorimeter can be utilized to record the display 102. In some implementations, the image data 112 is provided through upload by a remote device. Preprocessing can be performed on the image data 112 depending on the application. For example, in some implementations, the image data 112 is analyzed to identify the individual pixels depicted. The process can include edge detection algorithms, rotation of the image, cropping, etc.

From the image data 112, pixel information (e.g., luminance and/or chromaticity) can be obtained for the pixels shown in the image data 112. For example, the image data 112 can be an image frame of the entire display panel 102. In other implementations, the image data 112 shows a portion of the display panel 102. For example, the demura LUT generation process can be performed multiple times to process different portions of a given image frame. The image data 112 and pixel information correspond to a known, predetermined image (e.g., an image where the pixels are configured to display a predetermined grayscale value or any other predetermined pattern) that the display 102 is configured to output. For example, the image data 112 can include an image formed by the display 102 in response to a uniform signal sent across the pixels of the display 102 (i.e., the display is set to display a fixed grayscale level).

Due to various environmental factors and display properties, the obtained pixel information can deviate from the intended image. These deviations are calculated as error values 116 using an error calculation module 118. The error calculation module 118 can be implemented in various ways to generate the error values. In the depicted example, the error calculation module 118 utilizes the pixel information from the image data 112 and target values 120 to calculate an error value 116 for each individual pixel. The error calculation module 118 can be implemented in various ways. For example, the error calculation module 120 can, for each pixel, perform a subtraction between the pixel information for the pixel and its corresponding target value 120. In some implementations, the pixel information is divided by the target values 120 to generate gain values. Inverse gain generation can also be performed. The target values 120 represent the pixel values that the display 102 is configured to output. In some implementations, the target values 120 are derived from the signals sent to the display 102 for the display of the image corresponding to the retrieved image data 112. For example, if the display 102 is configured to output a uniform grayscale image, the grayscale value for such as image can be utilized as the target values 120.

Generally, the pixel information of the image data 112 is derived from at least a combination of real pixel luminance information, environmental light noise, camera system variation, driver noise, and other variables that can vary over time. As such, error values 116 calculated for a given image frame can be inaccurate for subsequent image frames. To more accurately generate the demura LUT 110 to account for these variables, the demura LUT generation program 108 includes a control loop module 122. The control loop module 112 includes one or more control loops that provide an output 124 used to adjust the demura LUT 110. Various types of control loops can be implemented, including but not limited to the use of filters. In some implementations, the control loop module 122 includes a PID controller implementing one or more PID control loops.

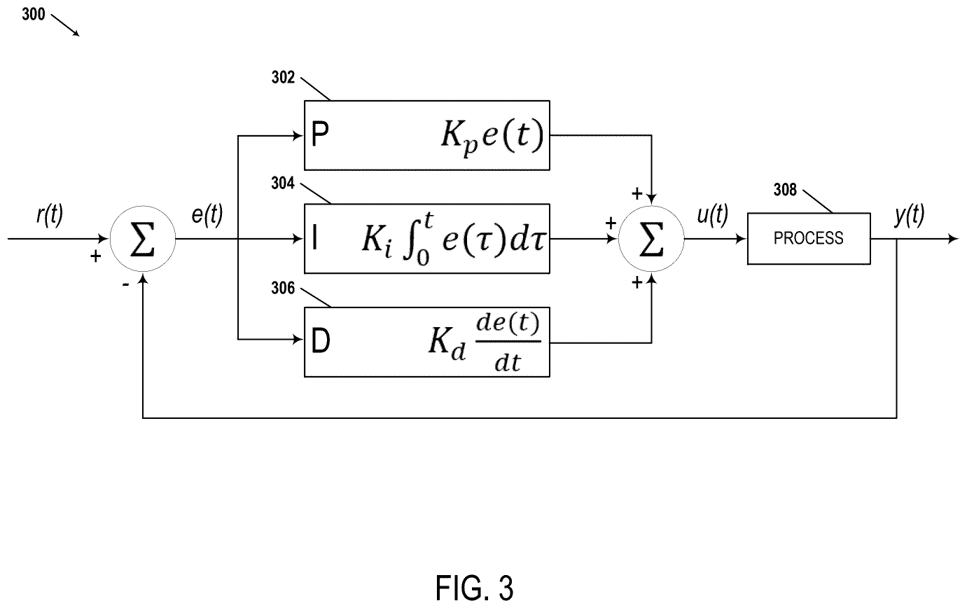

A PID control loop can be implemented to mitigate noise and variation impacts using one or more of a proportional, an integrator, or a derivative term. In some implementations, the PID control loop includes all three terms. An integrator term can be utilized to “average” incoming luminance information from different image frames. Proportional and derivative terms can be used to accelerate the process, thus saving processing time and power. Furthermore, the proportional and derivative terms can mitigate the oscillations from the quantization error produced by the integrator term. In some implementations, the PID controller includes a proportional term, an integrator term, and a derivative term that can be tuned, providing flexibility to the demura LUT generation process. For example, each term can include a coefficient that is configurable by the PID controller. The terms can be tuned for various reasons. In some implementations, the terms are tuned individually for each pixel (e.g., based on different environmental conditions, different cameras etc.). Additionally or alternatively, the terms can be tuned to reduce or eliminate their influence on the control loop (e.g., setting coefficients of one or more terms to zero). PID control loops are described in further detail with respect to FIG. 3.

Use of control loops in an iterative manner provides several technical advantages. A control loop, such as a PID control loop, can adapt to dynamic changes in the characteristics of the display 102 by continuously measuring and correcting the pixels. This provides the ability to compensate for nonlinear performance of the display 102. For example, in some cases, the relationship between a drive electrical signal and the corresponding illumination is nonlinear. The use of an iterative control loop can track this nonlinear relationship over time, providing improve uniformity corrections. Furthermore, changes in environmental factors such as lighting conditions and camera settings can be factored into the demura calculations by monitoring the changes in error values 116 over time. In some implementations, each pixel of the display 102 is associated with its individual control loop, allowing for each pixel's individual error to be fine-tuned. In some implementations, pixels are grouped based on a predetermined criterion, and a different control loop is implemented for each group. For example, the pixels can be grouped by similar luminance performance, and each group can be adjusted by a respective PID controller. This form of control enables high accuracy and uniformity across the display 102. Furthermore, the tunability of the control loops allow for the demura LUT to be tuned to different display models and/or user preferences.

After the demura LUT 110 is updated using the output 124 of the control loop module 122, the updated demura LUT 110 can be utilized to adjust the output of display 102. The adjusted output can then be recorded to provide updated pixel information with which the demura LUT generation program can use to process and continue to further update the demura LUT 110. This iterative process makes use of the control loop and historical error values to provide more accurate demura parameters. For example, a PID control loop can be implemented with integrator and derivative terms that track the changes of error values 116 over time and utilizes such information to update the demura LUT 110. In some implementations, the iterative process is performed for a given image frame until the error values 116 are below a predetermined threshold.

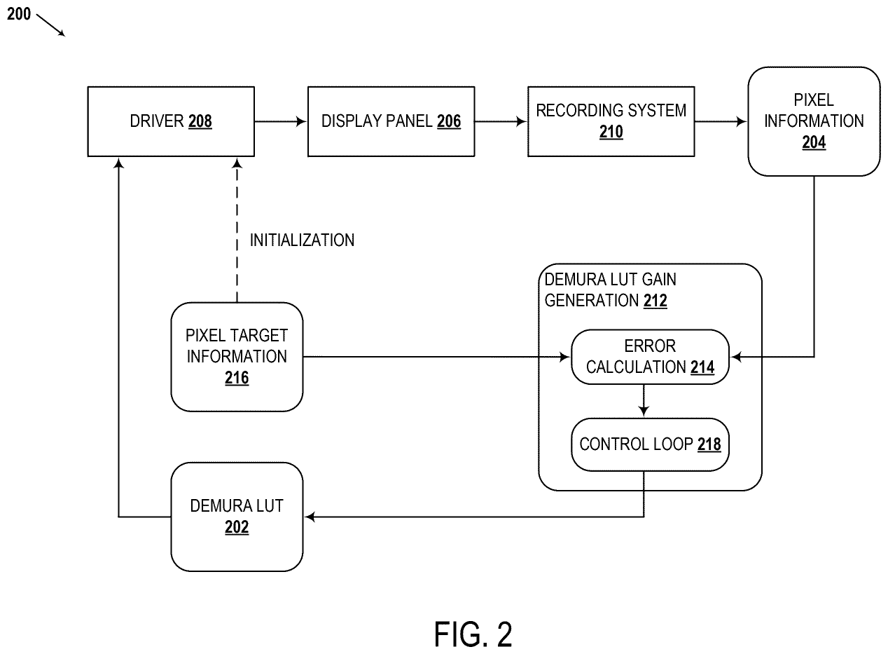

FIG. 2 shows a block diagram of an example algorithm 200 for performing demura look-up table gain generation using control loops. The example algorithm 200 can include the initialization of a demura LUT 202. For example, an initial demura LUT can be generated with initial values, such as zeroes, ones, or average correction factors. In other implementations, the demura LUT 202 is an existing LUT, and the algorithm 200 is performed to update the LUT. The example algorithm 200 starts with obtaining pixel information 204, which can correspond to a single image frame captured from a display panel 206. The example algorithm 200 can be performed iteratively for successive frames in a similar manner.

The pixel information 204 can be obtained in various ways. In the depicted example, a first iteration of the algorithm 200 can be performed by initializing the display panel 206 to display a known image (e.g., a grayscale image or an image with a known pattern). Signals corresponding to pixel values of the known image are sent to a display driver 208 that configures the display panel 206 to output the known image. A recording system 210 is implemented to record the output of the display panel 206 and to provide the pixel information 204. Various types of recording systems can be utilized, including but not limited to a colorimeter and a camera system.

The obtained pixel target information 208 can include different types of information, which can depend on the application. In some implementations, the pixel information 204 includes luminance/brightness values. Alternatively or additionally, the pixel information 204 includes chromaticity/color values. A demura LUT gain generation process 212 is then performed using the pixel information 204. The process 212 includes calculation 214 of error values using the pixel information 204 and pixel target information 216. Pixel target information 216 can be provided in various ways. In the depicted example, the pixel target information 216 corresponds to the signals used to initialize the display panel 206 for the display of the known image. The error calculation 214 can be performed in various ways. For example, subtraction of a pixel value in the pixel information 204 and a corresponding target pixel value in the pixel target information 216 can be performed for each pixel. In some implementations, gain values (or inverse gain values) are determined.

Error values from the error calculation 214 are then fed into a control loop 218. The control loop 218 is applied to each pixel's error to generate an output for each pixel. These outputs can then be used to update each pixel's correction value in the demura LUT 202. The algorithm 200 can be performed in an iterative manner. In some implementations, the updated demura LUT 202 is utilized to send updated signals to the display driver 208 to generate an updated image that should more resemble the pixel target information 216 compared to the original, known image (or previously updated image). Pixel information for the updated image can be obtained, and another loop of the algorithm 200 can be performed to further update the demura LUT 202. As the control loop 218 can be implemented to retain knowledge of previously calculated error values, trends of calculated error values in successive loops can be used to more accurately generate gain values that provide correction values for achieving the target pixel values. This iterative process can be performed for a given image frame until a predetermined criterion is met. For example, the process can be performed until the calculated error values are below a predetermined threshold.

The control loop 218 depicted in the example algorithm 200 can be implemented in various ways. In some implementations, the control loop 218 includes at least one filter and/or at least one lead/lag compensator. In some implementations, the control loop 218 includes a PID controller that implements a PID control loop. FIG. 3 shows a block diagram illustrating an example proportional-integral-derivative control loop 300. The example PID control loop 300 shows a continuous flow that iteratively calculates an error value e(t), which is the difference between a setpoint SP=r(t) and a measured process variable PV=y(t). The setpoint is the desired value of the variable that is to be controlled, and the process variable is the actual value of the variable that is to be controlled. The error represents the difference between the setpoint and the process variable. In the examples of FIGS. 1 and 2, the setpoint can be the target luminance (and/or chromaticity) of the pixels, which can be defined by a standard or a user preference. The process variable can be the measured luminance (and/or chromaticity) of the pixels, which can be obtained by recording system (e.g., a colorimeter, a camera, etc.). Accordingly, the error would be the deviation of the measured values from the target values.

The PID control loop 300 attempts to minimize the error value e(t) over time through control and influence of three different terms. In the depicted example, the three terms include a proportional term 302, an integral term 304, and a derivative term 306. The proportional term is proportional to the current value of the error e(t) and provides a quick response to changes in the error. The proportional term includes a gain parameter Kₚ that determines how much the output changes with respect to the error. The integral term is proportional to the integral of the error over time and provides a steady-state response to eliminate any residual error. This adds a control effect based on historic values of the error. The integral term includes a gain parameter Kᵢ that determines how much the output accumulates with respect to the error. The derivative term is proportional to the derivative of the error over time and provides a predictive response to anticipate future changes in the error. The derivative term includes a gain parameter K_{d} that determines how much the output reacts to changes in the error rate. Different combinations of terms can also be implemented. For example, one or more of the proportional, integral, or derivative terms can be omitted. In some implementations, a term is omitted by setting its parameter K to zero. Furthermore, the balance of the effects of the control terms can be achieved by tuning the parameters K to produce an optimal control function (e.g., for a given scenario such as a preference or a different model of a display panel).

The PID control loop 300 attempts to minimize the error value e(t) over time by adjustment of a control variable u(t). In the depicted example, the overall output of the control variable if given by the following formula:

$$u ( t ) = {K}_{p} e ( t ) + {K}_{i} {\int }_{0}^{t} e ( τ ) d τ + {K}_{d} \frac{de ( t )}{dt} ,$$

where Kₚ, Kᵢ, and K_{d} are non-negative and denote the coefficients for the proportional, integral, and derivative terms, respectively. In the case of demura LUT generation as described herein, the control variable u(t) can be implemented as the correction value for each pixel (which can be stored in a demura LUT). Referring to the processes described in FIGS. 1 and 2, each iteration of the control variable u(t) can be used to update the correction value for each pixel in the demura LUT.

The control variable u(t) can be adjusted (using one or more of the terms described above) to influence the process variable y(t) through a process function 308. For example, in the context of the demura LUT generation process described in FIGS. 1 and 2, the process function 308 can include applying correction values to the display output. The luminance from such output can be measured to provide the process variable y(t), which can be used to update the error value e(t) to perform another control loop.

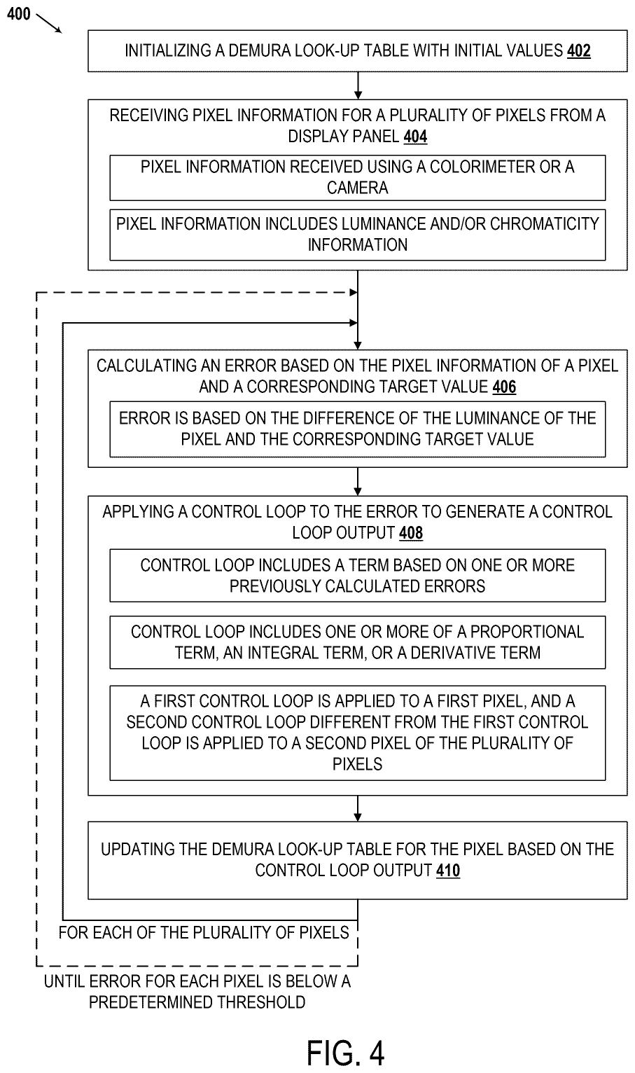

FIG. 4 shows a flow diagram of an example method 400 for performing demura look-up table gain generation using control loops. The method 400 includes, at step 402, initializing a demura look-up table with initial values. The demura look-up table can be initialized in various ways. In some implementations, the demura look-up table is initialized with zeroes. In other implementations, the demura look-up table is initialized with predetermined correction values. For example, average correction values, such as known values for a given model of a display panel, can be utilized. In other implementations, the demura look-up table is based on a previously generated demura look-up table. For example, the method 400 as described can be implemented to recalibrate and to update a demura look-up table previously generated for the given display panel.

The method 400 includes, at step 404, receiving pixel information for a plurality of pixels from a display panel. Various types of display devices can be implemented. Examples of displays include LCD, LED, OLED, QLED, and μLED. The pixel information can include various characteristics of the plurality of pixels. In some implementations, the pixel information includes brightness or luminance values for each of the plurality of pixels. In some implementations, the pixel information includes chromaticity or color values for each of the plurality of pixels. The pixel information can be received in various ways. For example, a camera system, a colorimeter, or any other appropriate recording apparatus can be utilized to record the output of the display panel. In some implementations, the recording apparatus provides a video recording, and the received pixel information is derived from the video recording. For example, pixel information for the pixels of a given image frame from the video recording can be used. Subsequent frames can be processed similarly using the method 400 described herein. The plurality of pixels can represent an entire image frame of the entire display panel. In other implementations, the plurality of pixels represents a portion of the display panel. In such cases, the method 400 described herein can be performed on different portions that make up an entire image frame.

The method 400 includes, at step 406, calculating an error based on the pixel information of a pixel and a corresponding target value. In some implementations, the error is calculated based on a difference of a luminance (or chromaticity) value of a pixel and its corresponding target luminance (or chromaticity) value. In some implementations, a division operation is applied. For example, a fraction based on the luminance (or chromaticity) value of a pixel value of a pixel and its corresponding target luminance (or chromaticity) value can be calculated to generate a gain value. In some implementations, an inverse gain value is determined. The target value can be derived in various ways. In some implementations, the target value corresponds to the electronic signal for controlling the corresponding pixel from which the pixel information is derived. Different pixels may have different target values. In some implementations, the plurality of pixels has the same target value (e.g., if the image from which the pixel information is obtained is a uniform grayscale image).

The method 400 includes, at step 408, applying a control loop to the error to generate a control loop output. Various types of control loops can be implemented. In some implementations, the control loop includes at least one filter. In some implementations, the control loop includes a proportional-integral-derivative control loop. For example, the control loop can be applied by a PID controller. In some implementations, the influence of one or more of the terms of the PID control loop is reduced or eliminated. Different control loops can be applied to different pixels. In some implementations, a first control loop is applied to a first pixel, and a second control loop different from the first control loop is applied to a second pixel. For example, coefficients of the terms of a PID control loop can be adjusted differently for each pixel.

The method 400 includes, at step 410, updating the demura look-up table for the pixel based on the control loop output. Steps 406-410 can be repeated for each pixel of the plurality of pixels, resulting in updating the demura look-up table for every pixel. In some implementations, the process can be repeated until a predetermined criterion is met. For example, the process of calculating errors, calculating control loop outputs, and updating the demura look-up table can be repeated for a given image frame for a number of iterations. In some implementations, the process is performed until the calculated error for each pixel (or a subset of the plurality of pixels) is below a predetermined threshold. Furthermore, the method 400 can be repeated for subsequent image frames of a given video recording using the updated demura look-up table.

In some embodiments, the methods and processes described herein may be tied to a computing system of one or more computing devices. In particular, such methods and processes may be implemented as a computer-application program or service, an application-programming interface (API), a library, and/or other computer-program product.

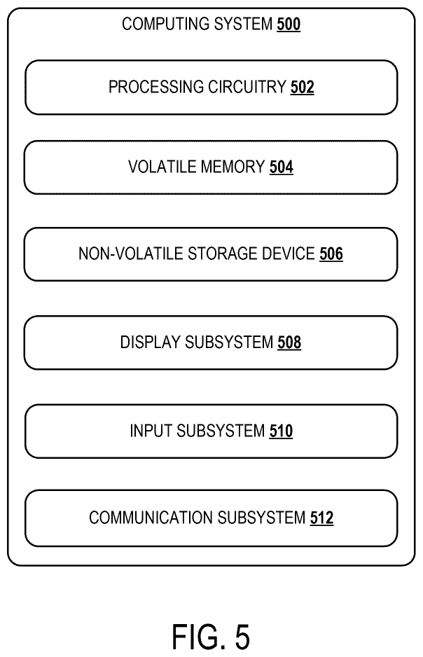

Computing system 500 includes a logic processor 502 volatile memory 504, and a non-volatile storage device 506. Computing system 500 may optionally include a display subsystem 508, input subsystem 510, communication subsystem 512, and/or other components not shown in FIG. 5.

Logic processor 502 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 502 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 506 includes one or more physical devices configured to hold instructions executable by the logic processors to implement the methods and processes described herein. When such methods and processes are implemented, the state of non-volatile storage device 506 may be transformed—e.g., to hold different data.

Non-volatile storage device 506 may include physical devices that are removable and/or built in. Non-volatile storage device 506 may include optical memory, semiconductor memory, and/or magnetic memory, or other mass storage device technology. Non-volatile storage device 506 may include nonvolatile, dynamic, static, read/write, read-only, sequential-access, location-addressable, file-addressable, and/or content-addressable devices. It will be appreciated that non-volatile storage device 506 is configured to hold instructions even when power is cut to the non-volatile storage device 506.

Volatile memory 504 may include physical devices that include random access memory. Volatile memory 504 is typically utilized by logic processor 502 to temporarily store information during processing of software instructions. It will be appreciated that volatile memory 504 typically does not continue to store instructions when power is cut to the volatile memory 504.

Aspects of logic processor 502, volatile memory 504, and non-volatile storage device 506 may be integrated together into one or more hardware-logic components. Such hardware-logic components may include field-programmable gate arrays (FPGAs), program-and application-specific integrated circuits (PASIC/ASICs), program-and application-specific standard products (PSSP/ASSPs), system-on-a-chip (SOC), and complex programmable logic devices (CPLDs), for example.

The terms “module,” “program,” and “engine” may be used to describe an aspect of computing system 500 typically implemented in software by a processor to perform a particular function using portions of volatile memory, which function involves transformative processing that specially configures the processor to perform the function. Thus, a module, program, or engine may be instantiated via logic processor 502 executing instructions held by non-volatile storage device 506, using portions of volatile memory 504. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 508 may be used to present a visual representation of data held by non-volatile storage device 506. The visual representation may take the form of a graphical user interface (GUI). As the herein described methods and processes change the data held by the non-volatile storage device, and thus transform the state of the non-volatile storage device, the state of display subsystem 508 may likewise be transformed to visually represent changes in the underlying data. Display subsystem 508 may include one or more display devices utilizing virtually any type of technology. Such display devices may be combined with logic processor 502, volatile memory 504, and/or non-volatile storage device 506 in a shared enclosure, or such display devices may be peripheral display devices.

When included, input subsystem 510 may comprise or interface with one or more user-input devices such as a keyboard, mouse, touch screen, camera, or microphone.

When included, communication subsystem 512 may be configured to communicatively couple various computing devices described herein with each other, and with other devices. Communication subsystem 512 may include wired and/or wireless communication devices compatible with one or more different communication protocols. As non-limiting examples, the communication subsystem may be configured for communication via a wired or wireless local-or wide-area network, broadband cellular network, etc. In some embodiments, the communication subsystem may allow computing system 500 to send and/or receive messages to and/or from other devices via a network such as the Internet.

The following paragraphs provide additional description of the subject matter of the present disclosure. One aspect provides a method for performing demura gain generation, the method comprising: initializing a demura look-up table with initial values; receiving pixel information for a plurality of pixels from a display panel; and, for each of the plurality of pixels: calculating an error based on the pixel information of the pixel and a corresponding target value; applying a control loop to the error to generate a control loop output; and updating the demura look-up table for the pixel based on the control loop output. In this aspect, additionally or alternatively, the method further comprises: receiving updated pixel information for the plurality of pixels from the display panel; and, for each of the plurality of pixels: calculating an updated error based on the updated pixel information of the pixel and the corresponding target value; applying the control loop to the updated error to generate an updated control loop output; and further updating the updated demura look-up table for the pixel based on the updated control loop output. In this aspect, additionally or alternatively, the control loop includes a term based on one or more previously calculated errors. In this aspect, additionally or alternatively, the control loop comprises one or more of a proportional term, an integral term, or a derivative term. In this aspect, additionally or alternatively, the control loop comprises a proportional term, an integral term, and a derivative term. In this aspect, additionally or alternatively, a first control loop is applied to a first pixel of the plurality of pixels, and a second control loop different from the first control loop is applied to a second pixel of the plurality of pixels. In this aspect, additionally or alternatively, the method further comprises tuning one or more parameters of the control loop based on a user preference or a model of the display panel. In this aspect, additionally or alternatively, the pixel information is received using a colorimeter or a camera. In this aspect, additionally or alternatively, the pixel information comprises luminance information or chromaticity information. In this aspect, additionally or alternatively, a same control loop is applied for a subset of the plurality of pixels based on a predetermined criterion of luminance similarity.

Another aspect provides a computing system for performing demura gain generation, the computing system comprising processing circuitry and memory storing instructions that, during execution, causes the processing circuitry to: initialize a demura look-up table with initial values; receive pixel information for a plurality of pixels from a display panel; and, for each of the plurality of pixels: calculate an error based on the pixel information of the pixel and a corresponding target value; apply a control loop to the error to generate a control loop output; and update the demura look-up table for the pixel based on the control loop output. In this aspect, additionally or alternatively, the instruction, during execution, further causes the processing circuitry to: receive updated pixel information for the plurality of pixels from the display panel; and, for each of the plurality of pixels: calculate an updated error based on the updated pixel information of the pixel and the corresponding target value; apply the control loop to the updated error to generate an updated control loop output; and further update the updated demura look-up table for the pixel based on the updated control loop output. In this aspect, additionally or alternatively, the control loop includes a term based on one or more previously calculated errors. In this aspect, additionally or alternatively, the control loop comprises one or more of a proportional term, an integral term, or a derivative term. In this aspect, additionally or alternatively, the control loop comprises a proportional term, an integral term, and a derivative term. In this aspect, additionally or alternatively, a first control loop is applied to a first pixel of the plurality of pixels, and a second control loop different from the first control loop is applied to a second pixel of the plurality of pixels. In this aspect, additionally or alternatively, the instruction, during execution, further causes the processing circuitry to tune one or more parameters of the control loop based on a user preference or a model of the display panel. In this aspect, additionally or alternatively, the pixel information is received using a colorimeter or a camera. In this aspect, additionally or alternatively, the pixel information comprises luminance information or chromaticity information.

Another aspect provides a computing system for performing demura gain generation, the computing system comprising: a flat-panel display; a camera recording output of the flat-panel display; and processing circuitry and memory storing instructions that, during execution, causes the processing circuitry to: initialize a demura look-up table with initial values; receive a video source of the output of the flat-panel display from the camera, wherein the video source comprises a plurality of images; and, for each of the plurality of images: extract pixel information for a plurality of pixels from the image; and, for each of the plurality of pixels: calculate an error based on the pixel information of the pixel and a corresponding target value; apply a control loop to the error to generate a control loop output; and update the demura look-up table for the pixel based on the control loop output.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein. as well as any and all equivalents thereof.

1. A method for performing demura gain generation, the method comprising:
initializing a demura look-up table with initial values;
receiving pixel information for a plurality of pixels from a display panel; and
for each of the plurality of pixels:
calculating an error based on the pixel information of the pixel and a corresponding target value;
applying a control loop to the error to generate a control loop output; and
updating the demura look-up table for the pixel based on the control loop output.

2. The method of claim 1, further comprising:
receiving updated pixel information for the plurality of pixels from the display panel; and
for each of the plurality of pixels:
calculating an updated error based on the updated pixel information of the pixel and the corresponding target value;
applying the control loop to the updated error to generate an updated control loop output; and
further updating the updated demura look-up table for the pixel based on the updated control loop output.

3. The method of claim 1, wherein the control loop includes a term based on one or more previously calculated errors.

4. The method of claim 1, wherein the control loop comprises one or more of a proportional term, an integral term, or a derivative term.

5. The method of claim 1, wherein the control loop comprises a proportional term, an integral term, and a derivative term.

6. The method of claim 1, wherein a first control loop is applied to a first pixel of the plurality of pixels, and a second control loop different from the first control loop is applied to a second pixel of the plurality of pixels.

7. The method of claim 1, further comprising tuning one or more parameters of the control loop based on a user preference or a model of the display panel.

8. The method of claim 1, wherein the pixel information is received using a colorimeter or a camera.

9. The method of claim 1, wherein the pixel information comprises luminance information or chromaticity information.

10. The method of claim 1, wherein a same control loop is applied for a subset of the plurality of pixels based on a predetermined criterion of luminance similarity.

11. A computing system for performing demura gain generation, the computing system comprising:
processing circuitry and memory storing instructions that, during execution, causes the processing circuitry to:
initialize a demura look-up table with initial values;
receive pixel information for a plurality of pixels from a display panel; and
for each of the plurality of pixels:
calculate an error based on the pixel information of the pixel and a corresponding target value;
apply a control loop to the error to generate a control loop output; and
update the demura look-up table for the pixel based on the control loop output.

12. The computing system of claim 11, wherein the instruction, during execution, further causes the processing circuitry to:
receive updated pixel information for the plurality of pixels from the display panel; and
for each of the plurality of pixels:
calculate an updated error based on the updated pixel information of the pixel and the corresponding target value;
apply the control loop to the updated error to generate an updated control loop output; and
further update the updated demura look-up table for the pixel based on the updated control loop output.

13. The computing system of claim 11, wherein the control loop includes a term based on one or more previously calculated errors.

14. The computing system of claim 11, wherein the control loop comprises one or more of a proportional term, an integral term, or a derivative term.

15. The computing system of claim 11, wherein the control loop comprises a proportional term, an integral term, and a derivative term.

16. The computing system of claim 11, wherein a first control loop is applied to a first pixel of the plurality of pixels, and a second control loop different from the first control loop is applied to a second pixel of the plurality of pixels.

17. The computing system of claim 11, wherein the instruction, during execution, further causes the processing circuitry to:
tune one or more parameters of the control loop based on a user preference or a model of the display panel.

18. The computing system of claim 11, wherein the pixel information is received using a colorimeter or a camera.

19. The computing system of claim 11, wherein the pixel information comprises luminance information or chromaticity information.

20. A computing system for performing demura gain generation, the computing system comprising:
a flat-panel display;
a camera recording output of the flat-panel display; and
processing circuitry and memory storing instructions that, during execution, causes the processing circuitry to:
initialize a demura look-up table with initial values;
receive a video source of the output of the flat-panel display from the camera, wherein the video source comprises a plurality of images; and
for each of the plurality of images:
extract pixel information for a plurality of pixels from the image; and
for each of the plurality of pixels:
calculate an error based on the pixel information of the pixel and a corresponding target value;
apply a control loop to the error to generate a control loop output; and
update the demura look-up table for the pixel based on the control loop output.
